(19) United States
(12) Patent Application Publication
(10) Pub. No.: US 2026/0075163 A1
(43) Pub. Date: Mar. 12, 2026

(54) IMPLEMENTING ARTIFICIAL INTELLIGENCE INCLUDING COMPUTER VISION TO PROTECT SENSITIVE INFORMATION DISCLOSURE DURING A VIDEO CALL OR CONFERENCE

(71) Applicant: BANK OF AMERICA CORPORATION, Charlotte, NC (US)

(72) Inventors: Kyle Mayers, Charlotte, NC (US); Eran Hauser, Charlotte, NC (US); Mohamed Faris Khaleeli, Charlotte, NC (US); Elizabeth R. Liuzzo, Fort Mill, SC (US); Justin Miller, Fort Mill, SC (US)

(73) Assignee: BANK OF AMERICA CORPORATION, Charlotte, NC (US)

(21) Appl. No.: 18/827,025

(22) Filed: Sep. 6, 2024

(51) Int. Cl. H04N 7/15; H04N 7/14

(52) U.S. Cl. CPC H04N 7/152; H04N 7/147

(57) ABSTRACT

Protection of sensitive data, such as Non-Public Information (NPI) in a video call/conference environment. In response to initiating a video call/conference amongst multiple call participants, Artificial Intelligence is implemented to monitor for detection of sensitive data in the video feed and/or audio feed being transmitted by a call participant. In response to detecting sensitive data in the video feed or the audio feed, the invention is configured to perform one or more actions that prevent one or more other call participants participating in the video call from viewing and/or hearing the sensitive data in the video feed or the audio feed. The sensitive data may be found in text indicia or images displayed in the video call field of view, individuals heard or seen in the background of the video call or the like.

### FIELD OF THE INVENTION

The present invention is generally directed to data security and, more specifically, preventing leakage of sensitive data, such as non-public information (NPI) or the like, within a video call/conference environment.

### BACKGROUND

Video calls and video conferences have become a preferred means for communication between two or more call participants. In the instance of large video conferences, with hundreds of call participants many of the call participants may be unknown to the one or more of the other call participants. It is also not outside the realm of possibility that large video conferences may include uninvited call participants, so called “intruders” or “gate crashers” which may attend the video conferences with bad intentions, such as acquiring sensitive data, specifically non-public information (NPI) from the call participants or the like.

While call participants may intentionally or unintentionally disclose sensitive data during a video conference when they are the designated speaker, there are other means by which sensitive data is disclosed or otherwise becomes available during a video conference. For example, a call participant's background (i.e., the area behind the video call participant that is within view of the video call participant's image-capturing device (i.e., video camera or the like)) may include sensitive data (e.g., names, addresses on a whiteboard, photographic images of friends, family members or the like). In addition, other individuals (e.g., children, spouses or the like) may unknowingly either utter speech that includes sensitive data or may enter the within view of the video call participant's image-capturing device (i.e., video camera or the like).

Therefore, a need exists to develop systems, computer-implemented methods, computer program products or the like that serve to effectively and efficiently protect sensitive information, such as NPI, during a video call/conference. Specifically, the desired systems and the like should serve to prevent the unintended disclosure of sensitive data or the like that shows up in the background of a video call participant's field of view, such as text/indicia, images, as well as, unintended individuals and their speech who may enter into the field of view or be heard in the background.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for protection of sensitive data, such as Non-Public Information (NPI) or the like in video call/conference environment. Specifically, in response to initiating a video call/conference amongst multiple call participants, Artificial Intelligence (AI) is implemented to monitor for detection of sensitive data in the video feed and/or audio feed being transmitted by a call participant. In response to detecting sensitive data in the video feed or the audio feed, the invention is configured to perform one or more actions that prevent one or more other call participants participating in the video call from viewing and/or hearing the sensitive data in the video feed or the audio feed.

In specific embodiments of the invention, the AI, specifically computer vision and optical character recognition (OCR) techniques and implemented to detect the sensitive data. In such embodiments, the NPI is text indicia displayed in a background of the video feed. In other embodiments of the invention, the AI, specifically computer vision and facial recognition techniques are implemented to detect the sensitive data. In such embodiments, the sensitive data is (i) an actual individual in the video feed other than the first call participant or (ii) an image of individual in the video feed other than the first call participant. In related embodiments of the invention, the one or more actions includes obfuscating a region within the video feed where (i) the text indicia appears, or (ii) the actual individual or the image of the individual appears.

In other specific embodiments of the invention, the AI, specifically computer vision and voice recognition techniques are implemented to detect the sensitive data. Detection includes identifying one or more secondary voices in the audio feed other than a voice of the primary call participant and the sensitive data is any audio coming from the identified one or more secondary voices. In specific related embodiments of the invention, the AI, the voice recognition techniques and the Natural Language Processing are implemented to detect the sensitive data. Detection further includes implementing the NLP to determine that the audio coming from the identified one or more secondary voices includes sensitive data. In related embodiments of the system, the one or more actions include implementing noise reduction techniques to mute the audio coming from the identified one or more secondary voices.

A system for sensitive data leakage prevention defines first embodiments of the invention. The system includes a computing platform having a memory, at least one computing processor device in communication with the memory and an image capturing device in communication with one or more of the at least one computing processor device. The computer platform additionally includes a video call/conference application in communication with the image-capturing device and including Artificial Intelligence (AI). The video call/conference application is stored in the memory and is executable by one or more of the at least one computing processor device. The video call/conference application is configured to initiate a video call amongst a plurality of call participants, and implement the AI to monitor for detection of sensitive data in at least one of a video feed or an audio feed being transmitted by a first call participant from amongst the plurality of call participants. In response to detecting sensitive data in at least one of the video feed or the audio feed being transmitted by the first call participant, the video call/conference application is further configured to perform one or more actions that prevent one or more other call participants participating in the video call from at least one of viewing or hearing the sensitive data in the video feed or the audio feed.

In specific embodiments of the system, the video call application further includes the AI including computer vision and optical character recognition (OCR) techniques. In such embodiments of the system, the video call application is further configured to implement the AI including the computer vision and the OCR techniques to detect the sensitive data. The sensitive data is text indicia displayed in a background of the video feed. In related embodiments of the system, the video call application is further configured to perform the one or more actions that prevent the one or more other call participants participating in the video call from at least one of viewing the sensitive data in the video feed. The one or more actions includes obfuscating a region within the video feed where the text indicia appears.

In further specific embodiments of the system, the video call application further includes the AI including computer vision and facial recognition techniques. In such embodiments of the system, the video call application is further configured to implement the AI including the computer vision and the facial recognition techniques to detect the sensitive data. The sensitive data is at least one of (i) an actual individual in the video feed other than the first call participant and (ii) an image of individual in the video feed other than the first call participant. In related embodiments of the system, the video call application is further configured to perform the one or more actions that prevent the one or more other call participants participating in the video call from at least one of viewing the sensitive data in the video feed.

The one or more actions includes obfuscating a region within the video feed where the actual individual or the image of the individual appears.

In further specific embodiments of the system, the video call application further includes the AI including computer vision and voice recognition techniques. In such embodiments of the system, the video call application is further configured to implement the AI and the voice recognition techniques to detect the sensitive data. Detection includes identifying one or more secondary voices in the audio feed other than a voice of the first call participant and wherein the sensitive data is any audio coming from the identified one or more secondary voices. In specific related embodiments of the system, the video call application further includes Natural Language Processing (NLP). In such embodiments of the system, the video call application is further configured to implement the AI, the voice recognition techniques and the NLP to detect the sensitive data. Detection further includes implementing the NLP to determine that the audio coming from the identified one or more secondary voices includes sensitive data. In related embodiments of the system, the video call application is further configured to perform the one or more actions that prevent the one or more other call participants participating in the video call from hearing the sensitive data in the audio feed. The one or more actions includes implementing noise reduction techniques to mute the audio coming from the identified one or more secondary voices.

In still further specific embodiments of the system, the video call application is further configured to, in response to detecting sensitive data in at least one of the video feed or the audio feed being transmitted by the first call participant and prior to performing the one or more actions, receive permission from the first call participant to perform the one or more actions.

In other specific embodiments of the system, the video call application is further configured to detect that the first call participant is no longer in the video feed or no longer a primary subject in the video feed, and, in response to detecting that the that the first call participant is no longer in the video feed or no longer a primary subject in the video feed, pause or stop at least one of (i) capture of video by the image capture device or (ii) transmission of the video feed of the first call participant to the other call participants.

A computer-implemented method for sensitive data leakage prevention defines second embodiments of the invention. The computer-implemented method is executed by one or more computing processor devices. The method includes initiating a video call amongst a plurality of call participants and implementing Artificial Intelligence (AI) to monitor for detection of sensitive data in at least one of a video feed or an audio feed being transmitted by a first call participant from amongst the plurality of call participant. In response to detecting sensitive data in at least one of the video feed or the audio feed being transmitted by the first call participant, the computer-implemented method includes performing one or more actions that prevent one or more other call participants participating in the video call from at least one of viewing or hearing the sensitive data in the video feed or the audio feed.

In specific embodiments of the computer-implemented method, implementing further includes implementing the AI including computer vision and Optical Character Recognition (OCR) techniques to detect the sensitive data. In such embodiments, the sensitive data is text indicia displayed in a background of the video feed and performing further includes performing the one or more actions that prevent the one or more other call participants participating in the video call from viewing the sensitive data in the video feed. At least one of the one or more actions includes obfuscating a region within the video feed where the text indicia appears.

In still further specific embodiments of the computer-implemented method, implementing further includes implementing the AI including computer vision and facial recognition techniques to detect the sensitive data. In such embodiments, the sensitive data is at least one of (i) an actual individual in the video feed other than the first call participant and (ii) an image of individual in the video feed other than the first call participant. In such embodiments, performing further includes performing the one or more actions that prevent the one or more other call participants participating in the video call from viewing the NPI in the video feed. At least one of the one or more actions includes obfuscating a region within the video feed where the actual individual or the image of the individual appears.

In additional specific embodiments of the computer-implemented method, implementing further includes implementing the AI, voice recognition techniques and Natural Language Processing (NLP) to detect the sensitive data. Detection includes identifying one or more secondary voices in the audio feed other than a voice of the first call participant and implementing the NLP to determine that the audio coming from the identified one or more secondary voices includes sensitive data. In such embodiments of the computer-implemented method, performing further includes performing the one or more actions that prevent the one or more other call participants participating in the video call from at least one of hearing the sensitive data in the audio feed. At least one of the one or more actions includes implementing noise reduction techniques to mute the audio coming from the identified one or more secondary voices.

Moreover, in additional embodiments the computer-implemented method includes detecting that the first call participant is no longer in the video feed or no longer a primary subject in the video feed, and, in response to detecting that the that the first call participant is no longer in the video feed or no longer a primary subject in the video feed, pausing or stopping at least one of (i) capture of video by the image capture device or (ii) transmission of the video feed of the first call participant to the other call participants.

A computer program product including a non-transitory computer-readable medium defines third embodiments of the invention. The non-transitory computer-readable medium includes sets of codes. The sets of code cause one or more computing devices to initiate a video call amongst a plurality of call participants and implement Artificial Intelligence (AI) to monitor for detection of sensitive data in at least one of a video feed or an audio feed being transmitted by a first call participant from amongst the plurality of call participants. In response to detecting sensitive data in at least one of the video feed or the audio feed being transmitted by the first call participant, the sets of codes further cause the one or more computing devices to perform one or more actions that prevent one or more other call participants participating in the video call from at least one of viewing or hearing the sensitive data in the video feed or the audio feed.

In specific embodiments of the computer program product, the set of code for causing the one or more computing devices to implement are further configured to cause the one or more computing devices to implement the AI including computer vision and Optical Character Recognition (OCR) techniques to detect the sensitive data. In such embodiments of the computer program product, the sensitive data is text indicia displayed in a background of the video feed. In such embodiments of the computer program product, the set of code for causing the one or more computing devices to perform are further configured to cause the one or more computing devices to perform the one or more actions, specifically obfuscating a region within the video feed where the text indicia appears to prevent the one or more other call participants participating in the video call from viewing the sensitive data in the video feed.

In other specific embodiments of the computer program product, the set of code for causing the one or more computing devices to implement are further configured to cause the one or more computing devices to implement the AI including computer vision and facial recognition techniques to detect the sensitive data. In such embodiments of the computer program product, the sensitive data is at least one of (i) an actual individual in the video feed other than the first call participant and (ii) an image of individual in the video feed other than the first call participant. In such embodiments of the computer program product, the set of code for causing the one or more computing devices to perform are further configured to cause the one or more computing devices to perform the one or more actions, specifically obfuscating a region within the video feed where the actual individual or the image of the individual appears to prevent the one or more other call participants participating in the video call from viewing the NPI in the video feed, wherein the one or more actions includes.

In still further specific embodiments of the computer program product, the set of code for causing the one or more computing devices to implement are further configured to cause the one or more computing devices to implement the AI, voice recognition techniques and Natural Language Processing (NLP) to detect the sensitive data. Detection includes identifying one or more secondary voices in the audio feed other than a voice of the first call participant and implementing the NLP to determine that the audio coming from the identified one or more secondary voices includes sensitive data. In such embodiments of the computer program product, the set of code for causing the one or more computing devices to perform are further configured to cause the one or more computing devices to perform the one or more actions, specifically implementing noise reduction techniques to mute the audio coming from the identified one or more secondary voices to prevent the one or more other call participants participating in the video call from at least one of hearing the sensitive data in the audio feed.

Moreover, in additional specific embodiments of the computer program product, the sets of codes further include sets of code for causing the one or more computing device to detect that the first call participant is no longer in the video feed or no longer a primary subject in the video feed, and, in response to detecting that the that the first call participant is no longer in the video feed or no longer a primary subject in the video feed, pause or stop at least one of (i) capture of video by the image capture device or (ii) transmission of the video feed of the first call participant to the other call participants.

Thus, as described in detail above, present embodiments of the invention include apparatus, methods, computer program products and/or the like that provide for protection of sensitive data, such as Non-Public Information (NPI) or the like in video call/conference environment. Specifically, in response to initiating a video call/conference amongst multiple call participants, Artificial Intelligence (AI) is implemented to monitor for detection of sensitive data in the video feed and/or audio feed being transmitted by a call participant. In response to detecting sensitive data in the video feed or the audio feed, the invention is configured to perform one or more actions that prevent one or more other call participants participating in the video call from viewing and/or hearing the sensitive data in the video feed or the audio feed.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a system for preventing sensitive data leakage when a call participant is placed on mute during a video call/conference, in accordance with embodiments of the present invention;

FIG. 2 is a schematic/block diagram of a system for preventing non-public information (NPI) disclosure during video call/conference, in accordance with embodiments of the present invention;

FIG. 3 is a block diagram of a computing platform storing a video call/conference application configured preventing sensitive data leakage when a call participant is placed on mute during a video call/conference, in accordance with embodiments of present invention;

FIG. 4 is a block diagram of a computing platform storing a video call/conference application configured for preventing non-public information (NPI) disclosure during video call/conference, in accordance with embodiments of the present invention;

FIG. 5 is a flow diagram of a method for preventing sensitive data leakage when a call participant is placed on mute during a video call/conference, in accordance with embodiments of the present invention;

FIG. 6 is a flow diagram of a method for preventing non-public information (NPI) disclosure during video call/conference, in accordance with embodiments of the present invention;

FIG. 7 is a flow diagram of a method for preventing sensitive data leakage when a call participant is placed on mute during a video call/conference, in accordance with embodiments of the present invention;

FIG. 8 is a flow diagram of a method for preventing non-public information (NPI) disclosure during video call/conference, in accordance with embodiments of the present invention; and

FIG. 9 is a schematic diagram of an exemplary machine learning (ML) subsystem architecture, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized.

The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform includes a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide protection of sensitive data, such as Non-Public Information (NPI) or the like in video call/conference environment. Specifically, in response to initiating a video call/conference amongst multiple call participants, Artificial Intelligence (AI) is implemented to monitor for detection of sensitive data in the video feed and/or audio feed being transmitted by a call participant. In response to detecting sensitive data in the video feed or the audio feed, the invention is configured to perform one or more actions that prevent one or more other call participants participating in the video call from viewing and/or hearing the sensitive data in the video feed or the audio feed.

In specific embodiments of the invention, the AI, specifically computer vision and optical character recognition (OCR) techniques and implemented to detect the sensitive data. In such embodiments, the sensitive data is text indicia displayed in a background of the video feed. In other embodiments of the invention, the AI, specifically computer vision and facial recognition techniques are implemented to detect the sensitive data. In such embodiments, the sensitive data is (i) an actual individual in the video feed other than the first call participant or (ii) an image of individual in the video feed other than the first call participant. In related embodiments of the invention, the one or more actions includes obfuscating a region within the video feed where (i) the text indicia appears, or (ii) the actual individual or the image of the individual appears.

In other specific embodiments of the invention, the AI, specifically computer vision and voice recognition techniques are implemented to detect the sensitive data. Detection includes identifying one or more secondary voices in the audio feed other than a voice of the primary call participant and the sensitive data is any audio coming from the identified one or more secondary voices. In specific related embodiments of the invention, the AI, the voice recognition techniques and the Natural Language Processing are implemented to detect the sensitive data. Detection further includes implementing the NLP to determine that the audio coming from the identified one or more secondary voices includes sensitive data. In related embodiments of the system, the one or more actions include implementing noise reduction techniques to mute the audio coming from the identified one or more secondary voices.

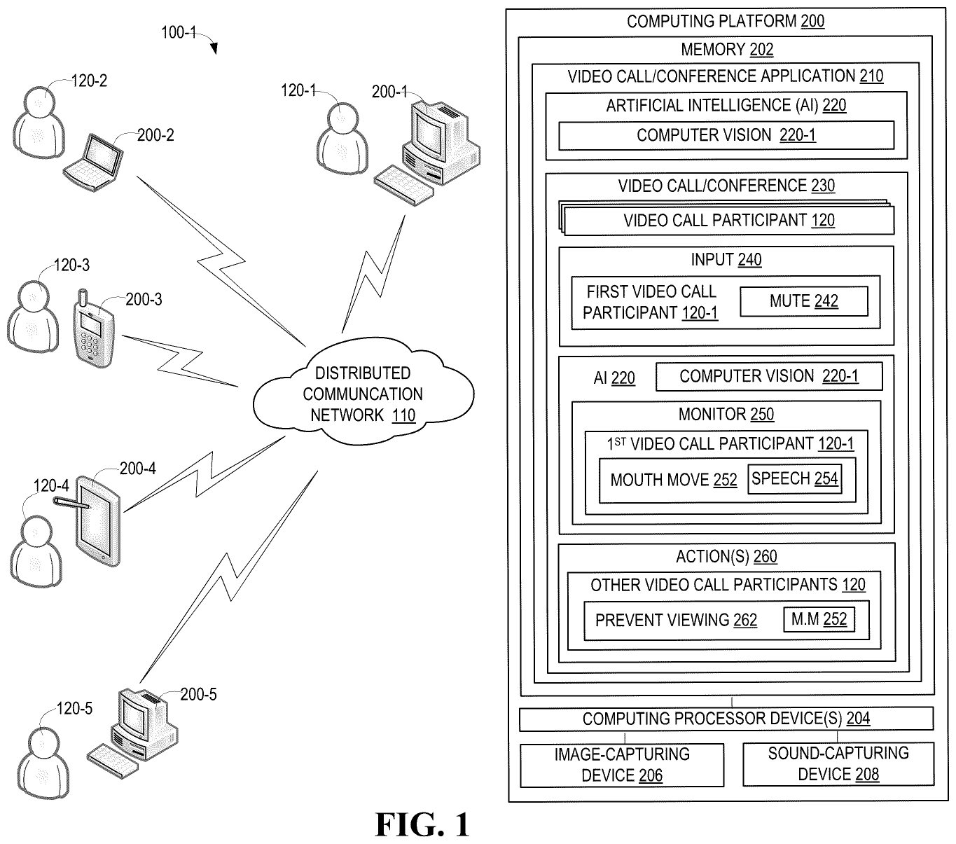

Referring to FIG. 1, a schematic/block is presented of a system 100-1 for prevention of sensitive data leakage, such as non-public information (NPI) during a video call/conference when a call participant is placed on mute, in accordance with embodiments of the present invention. Sensitive data, as used herein may include, but is not limited to, private data and/or confidential data, including personal data including name, address, biometric data, legal data, employment data, intellectual property data and the like. Non-Public Information is a special type of sensitive data protected under various laws, regulations and/or industry standards, such as, but not limited to, financial information (e.g., account numbers, transaction records, personal identification numbers and the like), health data and the like.

The system 100-1 is implemented amongst a distributed communication network 110, which may include the Internet, one or more intranets, cellular network(s) or the like. The system includes computing platforms 200-1-200-5, each associated with a corresponding video call participant 120-1-120-5. The computing platform 200 includes memory 202 and one or more computing processor devices 204 in communication with memory 202. Memory 202 stores video call/conference application 210, which is executable by at least one of the computing processor device(s) 204. Video call/conference application may a commercial application, such as WEBEX, ZOOM, Microsoft TEAMS or the like or may be a non-commercial custom application.

Video call/conference application 210 includes artificial intelligence 220, specifically computer vision 220-1, which is used to replicate the complexity of human vision and the human mind's ability to recognize objects, analyze scenes and understand visual cues. Video call/conference application 210 is configured to initiate a video call/conference 230 amongst a plurality of video call participants 120-1-120-5. In response to initiating the video call/conference 230, video call/conference application 210 is configured to receive an input 240 that is configured to place a first video call participant 120-1 on mute 242 (i.e., temporarily disable the sound-capturing device 208 (e.g., microphone)).

In response to placing the first video call participant 120-1 on mute 242, the video call/conference application is further configured to implement the AI 220, specifically the computer vision 220-1 to monitor 250 for mouth movement 252 by the first video call participant 120-1 that indicates speech 254. In this regard, the invention realizes that certain mouth movements will not indicate speech or otherwise rise to the level of speech and, thus, is able to discern between mouth movements 252 that indicate speech 254 and mouth movements 252 that do not indicate speech 254. The speech 254 may be the reason why the first video call participant 120-1 requested to be placed on mute 242. For example, the first video call participant 120-1 may need to conduct an offline conversation with a family member or conduct a secondary voice call with someone external from the video call/conference 230.

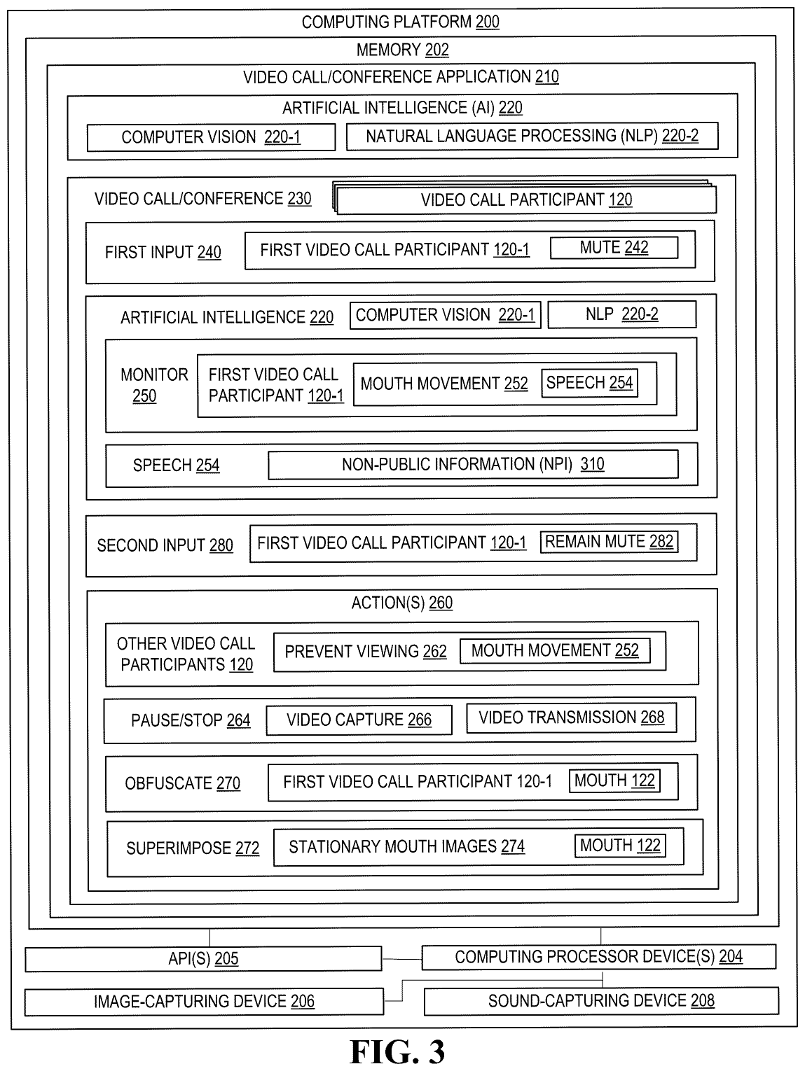

In response to the monitoring 250 detecting mouth movement 252 indicating speech 254 by the first video call participant 120-1, video call/conference application 210 is configured to perform one or more actions 260 that prevent viewing 262 of the mouth movements 252 by the other video call participants (120-2-120-5). In this regard, the present invention takes into account that the other video call participants (120-2-120-5) may be capable of speechreading (e.g., lip reading) or employ automated means, such as Artificial Intelligence, for speechreading, and, thus, discern what the first video call participant 120-1 is saying. Examples of the action(s) 260 that may be taking are discussed in more detail infra., in relation to FIG. 3.

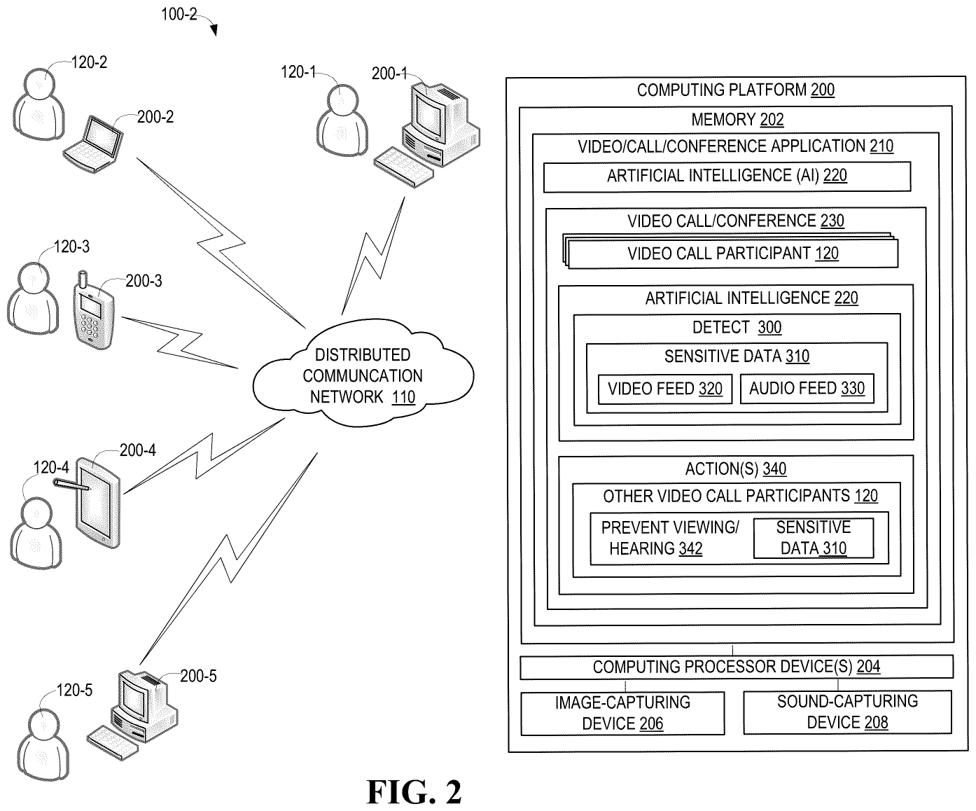

Referring to FIG. 2, a schematic/block is presented of a system 100-2 for prevention of sensitive data leakage in a video call/conference environment, in accordance with embodiments of the present invention. Sensitive data, as used herein may include, but is not limited to, private data and/or confidential data, including personal data including name, address, biometric data, legal data, employment data, intellectual property data and the like. Non-Public Information is a special type of sensitive data protected under various laws, regulations and/or industry standards, such as, but not limited to, financial information (e.g., account numbers, transaction records, personal identification numbers and the like), health data and the like.

The system 100-2 is implemented amongst a distributed communication network 110, which may include the Internet, one or more intranets, cellular network(s) or the like. The system includes computing platforms 200-1-200-5, each associated with a corresponding video call participant 120-1-120-5. The computing platform 200 includes memory 202 and one or more computing processor devices 204 in communication with memory 202. Memory 202 stores video call/conference application 210, which is executable by at least one of the computing processor device(s) 204. Video call/conference application may a commercial application, such as FACETIME, WEBEX, ZOOM, TEAMS or the like or may be a non-commercial custom application. Video call/conference application 210 includes artificial intelligence 220.

Video call/conference application 210 is configured to initiate a video call/conference 230 amongst a plurality of video call participants 120-1-120-5. In response to initiating the video call/conference 230, video call/conference application 210 is configured to implement the AI 220 to detect 300 sensitive data 310 in at least one of a video feed 320 or an audio feed 330 being transmitted by a first call participant 120-1 from amongst the plurality of call participants 120.

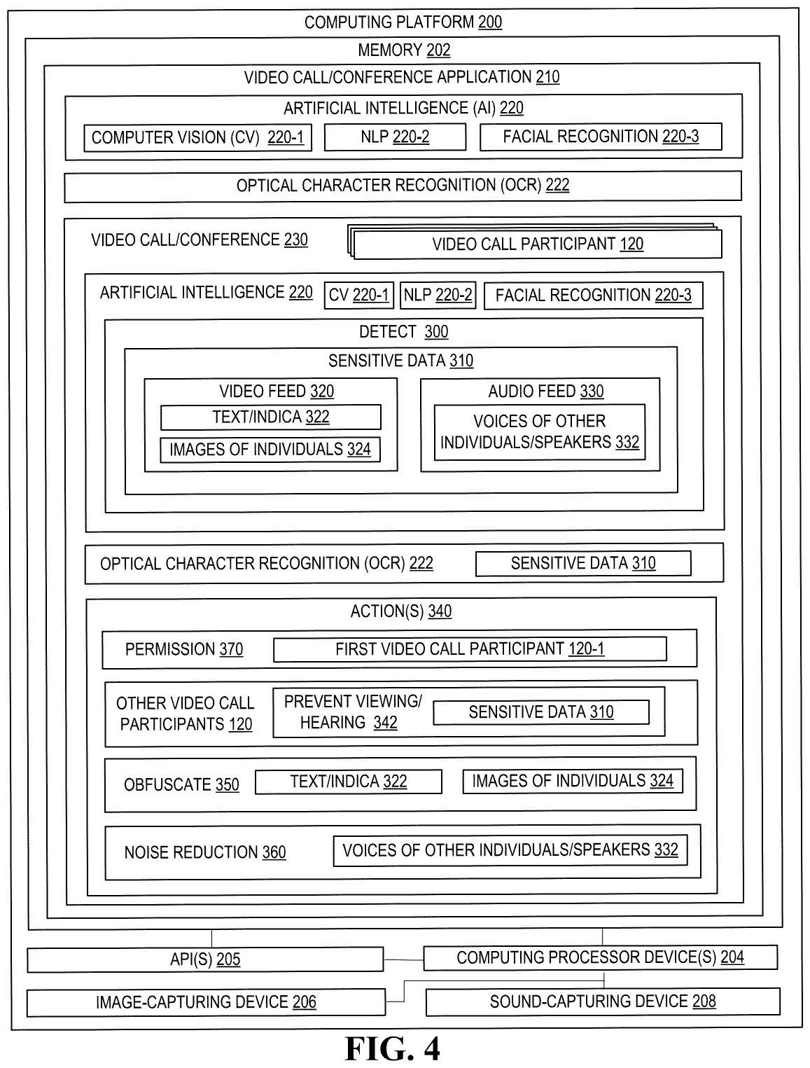

In response to detecting 300 the sensitive data 310 in at least one of the video feed 320 or the audio feed 330 of the first call participant 120-1, the video call/conference application 210 is configured to perform one or more actions 340 that prevent viewing or hearing 342 of the sensitive data 310 by one or more other video call participants 120 (e.g., 120-2-120-5). Examples of the action(s) 260 that may be taking are discussed in more detail infra., in relation to FIG. 4.

Referring to FIG. 3, a block diagram is depicted of computing platform 200 highlighting various alternate embodiments of the system shown and described in relation to FIG. 1, in accordance with embodiments of the present invention. Computing platform 200 may comprise one or multiple computing devices, such as personal computers (PCs), laptops, mobile communication devices (e.g., smart phones), tablet devices or the like or the like. As previously discussed in relation to FIG. 1, computing platform 200 includes memory 202, which may comprise volatile and/or non-volatile memory, such as read-only memory (ROM) and/or random-access memory (RAM), EPROM, EEPROM, flash cards, or any memory common to computing platforms. Moreover, memory 202 may comprise cloud storage, such as provided by a cloud storage service and/or a cloud connection service.

Further, computing platform 200 includes one or more computing processor devices 204, which may be an application-specific integrated circuit (“ASIC”), or other chipset, logic circuit, or other data processing device. Computing processor device(s) 204 may execute one or more application programming interface (APIs) 205 that interface with any resident programs, such as video call/conference application 210 or the like, stored in memory 202 of computing platform 200 and any external programs. Computing platform 200 includes various processing sub-systems (not shown in FIG. 3) embodied in hardware, firmware, software, and combinations thereof, that enable the functionality of computing platform 200 and the operability of computing platform 200 on a distributed communication network, such as distributed communication network 110 shown in FIG. 1. For example, processing sub-systems allow for initiating and maintaining communications and exchanging data with other networked devices. For the disclosed aspects, processing sub-systems of computing platform 200 includes any processing sub-system portion used in conjunction with s video call/conference application 210 and engines, tools, routines, sub-routines, applications, sub-applications, sub-modules thereof.

In specific embodiments of the present invention, computing platform 200 additionally includes a communications module (not shown in FIG. 3) embodied in hardware, firmware, software, and combinations thereof, that enables electronic communications between components of computing platform 200 and other networks and network devices. Thus, communication module includes the requisite hardware, firmware, software and/or combinations thereof for establishing and maintaining a network communication connection with one or more devices and/or networks.

As previously discussed in relation to FIG. 1, memory 202 stores video call/conference application 210 that is executable by one or more of the computing processor device(s) 204. Video call/conference application 210 includes Artificial Intelligence (AI) 220, specifically computer vision 220-1, which is used to replicate the complexity of human vision and the human mind's ability to recognize objects, analyze scenes and understand visual cues. In additional embodiments of the invention, AI 220 includes Natural Language Processing 220-2, which is capable of understanding and interpreting human language.

As previously discussed in relation to FIG. 1, video call/conference application 210 is configured to initiate a video call/conference 230 amongst a plurality of video call participants 120 (e.g., 120-1-120-5. In response to initiating the video call/conference 230, video call/conference application 210 is configured to receive an input, herein first input 240 that is configured to place a first video call participant 120-1 on mute 242 (i.e., temporarily disable the sound-capturing device 208 (e.g., microphone)).

In response to placing the first video call participant 120-1 on mute 242, the video call/conference application is further configured to implement the AI 220, specifically the computer vision 220-1 to monitor 250 for mouth movement 252 by the first video call participant 120-1 that indicates speech 254. In this regard, the invention realizes that certain mouth movements will not indicate speech or otherwise rise to the level of speech and, thus, is able to discern between mouth movements 252 that indicate speech 254 and mouth movements 252 that do not indicate speech 254. The speech 254 may be the reason why the first video call participant 120-1 requested to be placed on mute 242. For example, the first video call participant 120-1 may need to conduct an offline conversation with a family member or conduct a secondary voice call with someone external from the video call/conference 230.

In specific embodiments of the invention, the video call/conference application is further configured to implement the AI 220, specifically the NLP 220-2 to determine whether the speech 254 includes sensitive data 310, specifically Non-Public Information (NPI) 310-1 or the like.

In further specific embodiments of the invention, in response to the monitoring 250 detecting mouth movements 252 that indicate speech 254, the video call/conference application 210 is configured to receive a second input 280 that indicates that the first call participant 120-1 desires to remain muted 282. The present invention realizes that detection of mouth movement 252 that indicates speech 254 may be indicative of the video call participant 120-1 failing to realize that they are on mute 282 (i.e., the speech 254 may be intended for the video call/conference 230 but is not being transmitted because the video call participant 120-1 is on mute 242). As such, second input 280 may result from the video call/conference application 210 presenting the first video call participant 120-1, via a pop-up window or the like, an option to disable mute 242 (i.e., enable the sound-capturing device 208) or remain muted 282.

In response to the monitoring 250 detecting mouth movement 252 indicating speech 254 by the first video call participant 120-1 and in some embodiments of the invention determining that the speech 254 includes sensitive data 310, specifically NPI 310-1, video call/conference application 210 is configured to perform one or more actions 260 that prevent viewing 262 of the mouth movements 252 by the other video call participants (120-2-120-5). In this regard, the present invention takes into account that the other video call participants (120-2-120-5) may be capable of speechreading (e.g., lip reading) or employ automated means, such as Artificial Intelligence, for speechreading, and, thus, discern what the first video call participant 120-1 is saying.

The actions 260 may include pausing/stopping 264 at least one of (i) video capture 266 by the image-capturing device 206 and (ii) video transmission 268 of video captured by the image-capturing device 206. Further actions 260 may include continually identifying the region of the video that includes the mouth 122 of the first vide0 call participant 120-1 and obfuscating 270 (e.g., blurring, pixelating or the like) the identified region. In additional embodiments of the invention, actions 260 may include generating, using AI 220 or the like or retrieving from memory 202 one or more images 274 that depict a mouth of the first call participant in a stationary position and superimposing 272 the one or more images 274 over the mouth movements 252 in a video feed of the first call participant 120-1. In this regard, since the other video call participants see/view the mouth of the first video call participant 120-1 in a stationary position, the other video call participants 120 (e.g., 120-2-120-5) are led to believe that the first video call participant 120-1 is not engaged in speech.

Referring to FIG. 4, a block diagram is depicted of computing platform 200 highlighting various alternate embodiments of the system shown and described in relation to FIG. 2, in accordance with embodiments of the present invention. Computing platform 200 may comprise one or multiple computing devices, such as personal computers (PCs), laptops, mobile communication devices (e.g., smart phones), tablet devices or the like or the like. As previously discussed in relation to FIG. 2, computing platform 200 includes memory 202, which may comprise volatile and/or non-volatile memory, such as read-only memory (ROM) and/or random-access memory (RAM), EPROM, EEPROM, flash cards, or any memory common to computing platforms. Moreover, memory 202 may comprise cloud storage, such as provided by a cloud storage service and/or a cloud connection service.

Further, computing platform 200 includes one or more computing processor devices 204, which may be an application-specific integrated circuit (“ASIC”), or other chipset, logic circuit, or other data processing device. Computing processor device(s) 204 may execute one or more application programming interface (APIs) 205 that interface with any resident programs, such as video call/conference application 210 or the like, stored in memory 202 of computing platform 200 and any external programs. Computing platform 200 includes various processing sub-systems (not shown in FIG. 4) embodied in hardware, firmware, software, and combinations thereof, that enable the functionality of computing platform 200 and the operability of computing platform 200 on a distributed communication network, such as distributed communication network 110 shown in FIG. 2. For example, processing sub-systems allow for initiating and maintaining communications and exchanging data with other networked devices. For the disclosed aspects, processing sub-systems of computing platform 200 includes any processing sub-system portion used in conjunction with s video call/conference application 210 and engines, tools, routines, sub-routines, applications, sub-applications, sub-modules thereof.

In specific embodiments of the present invention, computing platform 200 additionally includes a communications module (not shown in FIG. 4) embodied in hardware, firmware, software, and combinations thereof, that enables electronic communications between components of computing platform 200 and other networks and network devices. Thus, communication module includes the requisite hardware, firmware, software and/or combinations thereof for establishing and maintaining a network communication connection with one or more devices and/or networks.

As previously discussed in relation to FIG. 2, memory 202 stores video call/conference application 210 that is executable by one or more of the computing processor device(s) 204. Video call/conference application 210 includes artificial intelligence 220, which may include computer vision 220-1, NLP 220-2 and facial recognition 220-3. In addition, video conference application 210 may include optical character recognition (OCR) 222, which may or may not AI techniques.

Video call/conference application 210 is configured to initiate a video call/conference 230 amongst a plurality of video call participants 120-1-120-5. In response to initiating the video call/conference 230, video call/conference application 210 is configured to implement the AI 220 to detect 300 sensitive data 310 in at least one of a video feed 320 or an audio feed 330 being transmitted by a first call participant 120-1 from amongst the plurality of call participants 120.

The sensitive data 310 in the video feed 320 may include, but is not limited to, text/indicia 322 that may show up in the background of the video feed 320 or is in the possession of first video call participant 120-1. For example, the text/indicia 322 may be on a whiteboard/chalkboard or the like or may printed on materials held by the first video call participant 120-1. In other instances, the sensitive data 310 in the video feed 320 may be images of individuals 324 other than the first video call participant 120-1. For example, the images of individuals 324 may be photographs of family members or friends in the background or may be actual individuals that come within the field of view of the image-capturing device 206. In specific embodiments of the invention, facial recognition 220-3 and/or optical character recognition 222 may be implemented to determine whether the text/indicia 322 or the images 324 includes sensitive data, or more specifically, non-public information (NPI).

The sensitive data 310 in the audio feed 330 may be voices of other individuals/speakers 332, such as family members, work colleagues or the like either addressing the first video call participant 102-1 or conducting conversations with other individuals. In specific embodiments of the invention, NLP 220-2 may be implemented to determine whether the output of the voices of the other individuals includes sensitive data, or more specifically non-public information (NPI).

In response to detecting 300 the sensitive data 310 in at least one of the video feed 320 or the audio feed 330 of the first call participant 120-1, the video call/conference application 210 is configured to perform one or more actions 340 that prevent viewing or hearing 342 of the sensitive data 310 by one or more other video call participants 120 (e.g., 120-2-120-5). In specific embodiments of the invention, prior to performing at least one of the one or more actions 340, the first video call participant 120-1 may be presented with a dialog box or the like that requests that the first video call participant 120-1 provide permission 370 for performing that at one of the one or more actions 340.

The actions 340 may include, but are not limited to obfuscation 350 (e.g., blurring, pixelating or the like) the text/indicia 322 and/or the images of the individuals 324. In other embodiments of the invention, the actions 340 may include, but are not limited to, implementing noise reduction 360 techniques to reduce or in some instances eliminate the background voices of other individuals/speakers 332.

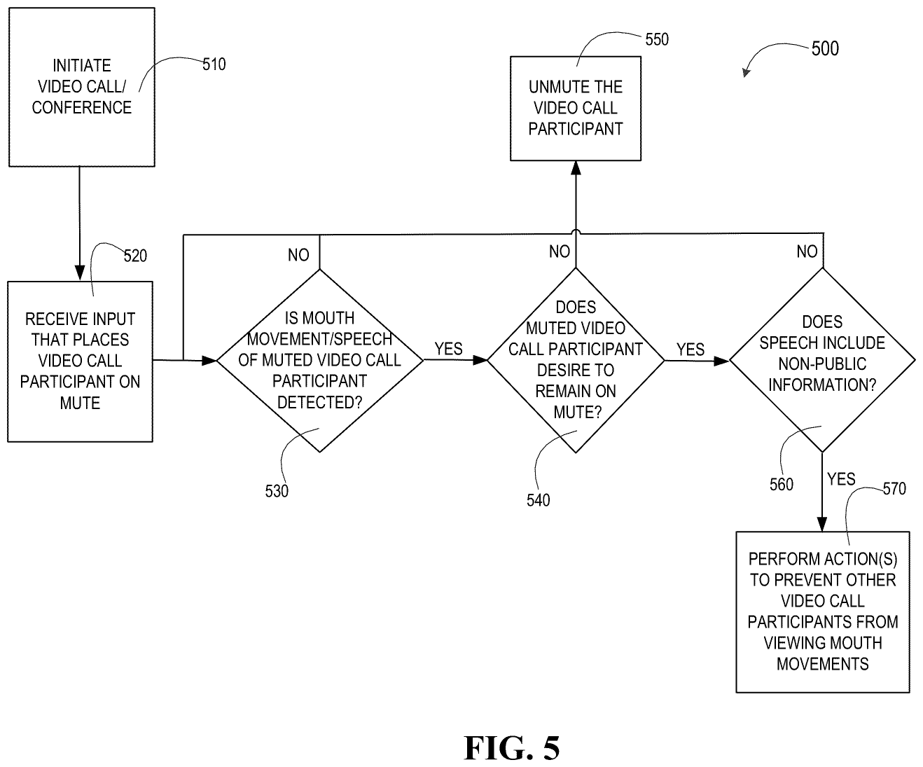

Referring to FIG. 5, a flow diagram is presented of a method 500 for prevention of sensitive data leakage, such as non-public information (NPI) during a video call/conference when a call participant is placed on mute, in accordance with embodiments of the present invention. At Event 510, a video call/conference is initiated amongst multiple video call participants and, at Event 520, an input is received from one of the video call participants that is configured to place the video call participant on mute (i.e., disable the microphone).

At Decision 530, a determination is made as to whether mouth movement, by the muted video call participant, which indicates speech is detected. If mouth movement indicating speech is not detected, the monitoring of the muted video call participant for mouth movement indicating speech continues as long as the video call participant remains on mute.

If mouth movement indicating speech is detected, at Decision 540, a determination is made as to whether the muted video call participant desires to remain on mute. In specific embodiments of the method, detection of mouth movement indicating speech may prompt a pop-up window or the like to be displayed which asks the video call participant if they desire to remain on mute. If the video call participant indicates that they no longer desire to remain on mute, at Event 550, the video call participant is unmuted (i.e., the microphone is activated, such that other video call participants can receive audio feed from the video call participant).

If the video call participant indicates that they desire to remain on mute, at Decision 560, a determination is made as to whether the speech includes non-public information, i.e., personal information that the video call participant would not want made public. Such a determination may be made via use of NLP or the like. If a determination is made the speech does not include non-public information, the method returns to visually monitoring the muted video call participant for mouth movements that indicate speech. If a determination is made that the speech does include NPI, at Event 570, one or more actions are performed that prevent other video call participants from viewing the mouth movements of the muted video call participant. Examples of other actions, include pausing or stopping the video feed (or the capture of video), obfuscating regions of the video feed that include the mouth of the muted video call participant or superimposing stationary images of the muted video call participant's mouth over the moving images.

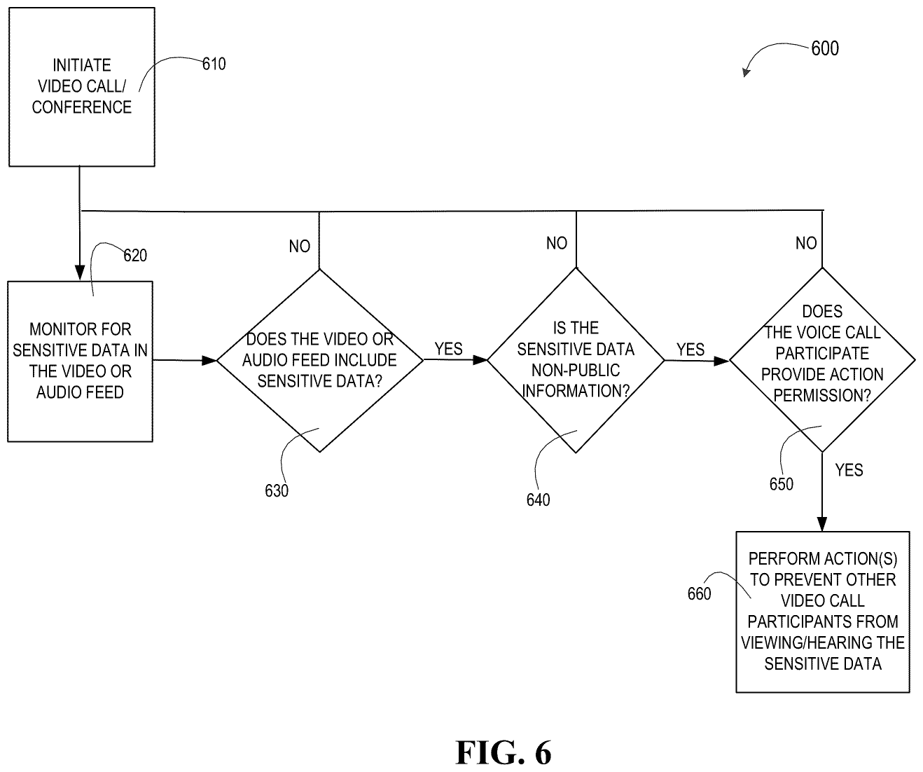

Referring to FIG. 6 a flow diagram is presented of a method 600 for prevention of sensitive data leakage, such as non-public information (NPI) during a video call/conference when a call participant is placed on mute, in accordance with embodiments of the present invention. At Event 610, a video call/conference is initiated amongst multiple video call participants and, at Event 620, the audio and video feed of the video call is monitored for sensitive data.

At Decision 630, a determination is made as to whether the video or audio feed includes sensitive data. If the video or audio feed does not include sensitive data, the method returns to Event 620 for further monitoring of the video call for sensitive data in the audio or video feed.

If sensitive data is detected in the audio or video feed, at Decision 640, a determination is made as to whether the sensitive data includes non-public information, i.e., personal information that the video call participant would not want made public. Such a determination may be made via use of NLP, OCR or the like. If a determination is made the sensitive data does not include non-public information, the method returns to Event 620 for further monitoring of the video call for sensitive data in the audio or video feed.

If the sensitive data does include non-public information, at Decision 650, a determination is made as to whether the voice call participate has provided permission for further actions. In specific embodiments of the method, detection of sensitive data or NPI may prompt a pop-up window or the like to be displayed which asks the video call participant if they desire for further actions to be taken on the sensitive data/NPI. If the video call participant does not provide permission, the method returns to Event 620 for further monitoring of the video call for sensitive data in the audio or video feed.

If the video call participant provides permission, at Event 660, one or more actions are performed that prevent other video call participants from viewing or hearing the sensitive data. Examples of other actions, include, but are not limited to, obfuscating regions of the video feed that include the sensitive data or implementing noise reduction in the audio feed to mask audible sensitive data/NPI.

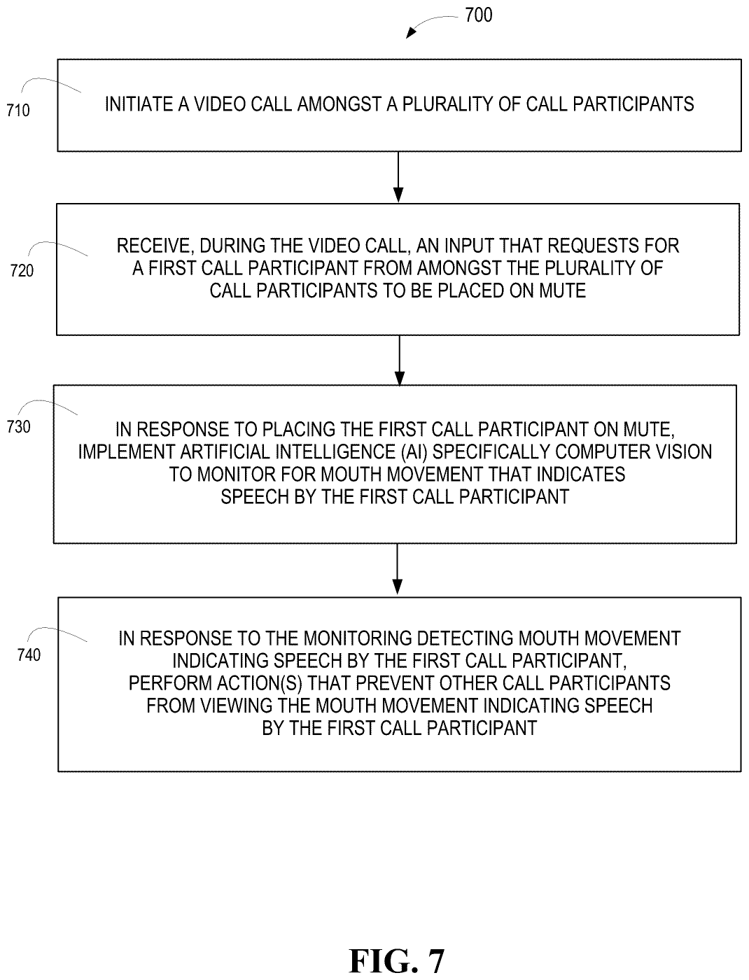

Referring to FIG. 7, a flow diagram is presented of a method 700 for prevention of sensitive data leakage, such as non-public information (NPI) during a video call/conference, in accordance with embodiments of the present invention. At Event 710, a video call/conference is initiated amongst a plurality of video call participants and, at Event 720, an input is received, during the video call/conference, which is configured to place one of the video call participants on mute (i.e., disable the video call participant's microphone).

In response to placing the video call participant on mute, at Event 730, artificial intelligence including computer vision is implemented to monitor for detection of mouth movement by the muted video call participant that indicates speech by the muted video call participant. In response to the monitoring detecting mouth movements that indicate speech by the muted video call participant, at Event 740, one or more actions are performed that prevent the other video call participants from viewing the mouth movements by the muted video call participant. The actions may include, but are not limited to, pausing or stopping the video feed (or the capture of video), obfuscating regions of the video feed that include the mouth of the muted video call participant or superimposing stationary images of the muted video call participant's mouth over the moving images.

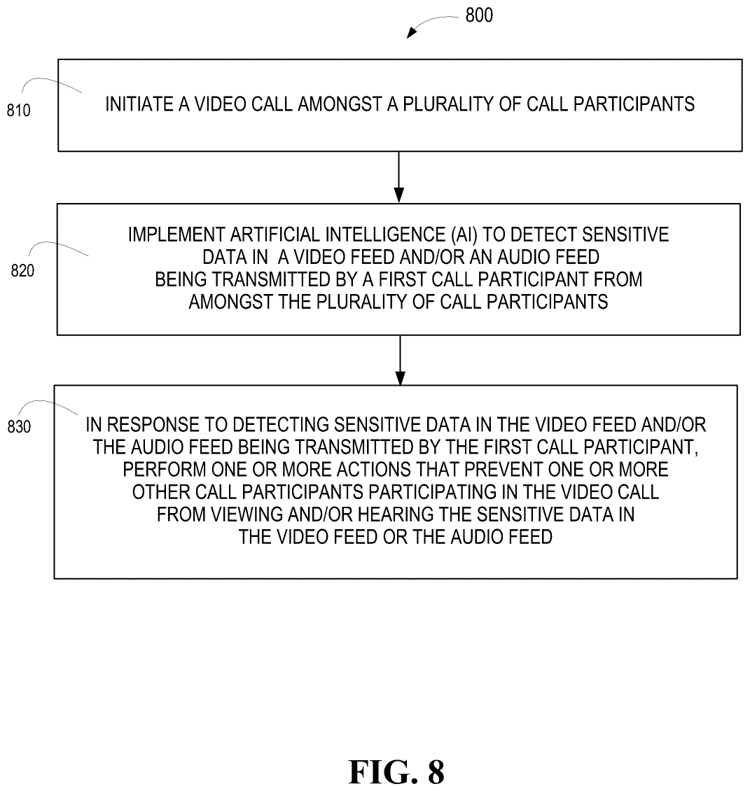

Referring to FIG. 8, a flow diagram is presented of a method 800 for prevention of sensitive data leakage in a video call/conference environment, in accordance with embodiments of the present invention. At Event 810, a video call/conference is initiated amongst a plurality of video call participants and, in response to initiating the video call/conference, at Event 820, artificial intelligence is implemented to monitor for detection of sensitive data in the captured images or sounds (i.e., in the video feed or the audio feed being transmitted by the first call participant to other video call participants). Sensitive data may include indicia/text displayed in the background of the video feed, images/photographs of individuals displayed in the background of the video feed, actual individuals that come within the field of view of the image-capturing device, and voices of other individuals that are picked up in the audio feed.

In response to detecting sensitive data in the video and/or audio feeds being transmitted by the video call participant, at Event 830, one or more one or more actions are performed that prevent the other video call participants from viewing or hearing the sensitive data. The actions may include, but are not limited to, obfuscating regions of the video feed that include the sensitive data (such as text/indicia, images or the like) or suppress the background audio to lessen or eliminate speech of other individuals.

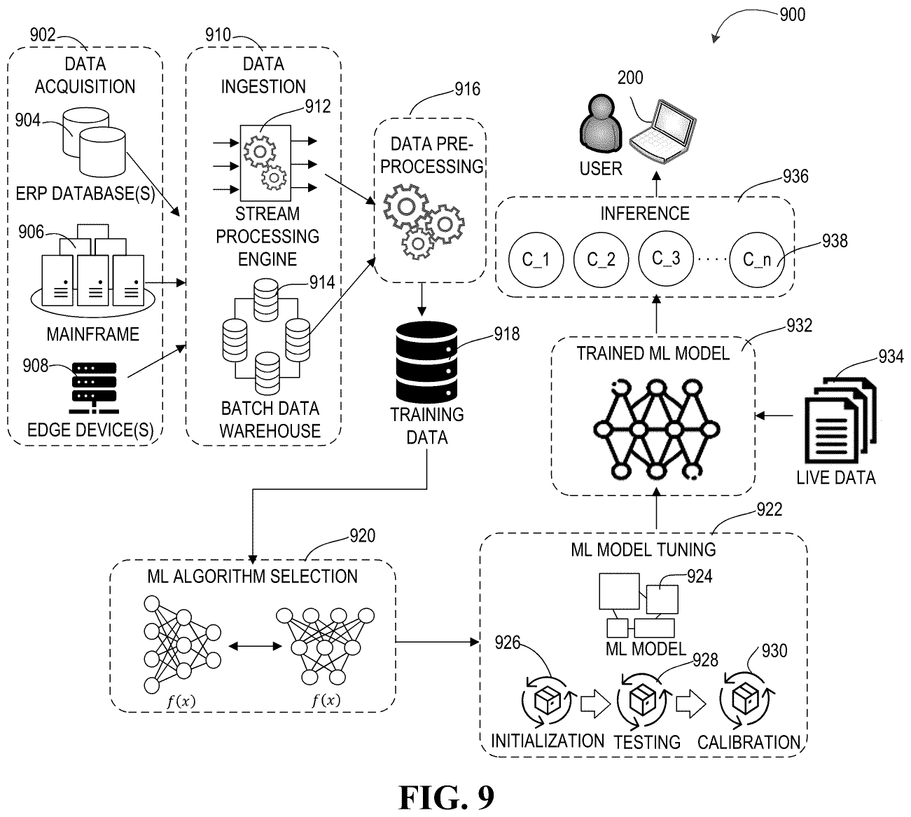

FIG. 9 illustrates an exemplary machine learning (ML) subsystem architecture 900, in accordance with an embodiment of the invention. The machine learning subsystem 900 includes a data acquisition engine 902, data ingestion engine 910, data pre-processing engine 916, ML model tuning engine 922, and inference engine 936.

The data acquisition engine 902 identifies various internal and/or external data sources to generate, test, and/or integrate new features for training the machine learning model 924. These internal and/or external data sources 904, 906, and 908 may be initial locations where the data originates or where physical information is first digitized. The data acquisition engine 902 identifies the location of the data and describes connection characteristics for access and retrieval of data. In some embodiments, data is transported from each data source 904, 906, or 908 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources include Enterprise Resource Planning (ERP) database(s) 904 that host data related to day-to-day business activities such as accounting, procurement, project management, exposure management, supply chain operations, and/or the like, mainframe 906 that is often the entity's central data processing center, edge device(s) 908 that may be any piece of hardware, such as sensors, actuators, gadgets, appliances, or machines, that are programmed for certain applications and can transmit data over the internet or other networks, and/or the like. The data acquired by the data acquisition engine 902 from these data sources 904, 906, and 908 is transported to the data ingestion engine 910 for further processing.

Depending on the nature of the data imported from the data acquisition engine 902, the data ingestion engine 910 may move the data to a destination for storage or further analysis. Typically, the data imported from the data acquisition engine 902 is in varying formats as the data comes from different sources, including Rational Database Management Systems (RDBMs), other types of databases, Simple Storage Service (S3) buckets, Commas-Separated Value (CSVs), or from streams. Since the data comes from different entities, the data needs to be cleansed and transformed so that it can be analyzed together with data from other sources. At the data ingestion engine 910, the data may be ingested in real-time, using the stream processing engine 912, in batches using the batch data warehouse 914, or a combination of both. The stream processing engine 912 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 914 collects and transfers data in batches according to scheduled intervals, trigger events, or any other logical ordering.

In machine learning, the quality of data and the useful information that can be derived therefrom directly affects the ability of the machine learning model 924 to learn. The data pre-processing engine 916 implements advanced integration and processing steps needed to prepare the data for machine learning execution. This includes modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 916 implements feature extraction and/or selection techniques to generate training data 918. Feature extraction and/or selection is a process of dimensionality reduction by which an initial set of data is reduced to more manageable groups for processing. A characteristic of these large data sets is a large number of variables that require sizeable computing resources to process. Feature extraction and/or selection may be used to select and/or combine variables into features, effectively reducing the amount of data that must be processed, while still accurately and completely describing the original data set. Depending on the type of machine learning algorithm being used, training data 918 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 922 may be used to train a machine learning model 924 using the training data 918 to make predictions or decisions without explicitly being programmed to do so. The machine learning model 924 represents what was learned by the selected machine learning algorithm 920 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 922 repeatedly executes cycles of initialization/experimentation 926, testing 928, and tuning 930 to optimize the performance of the machine learning model 924 and refine the results in preparation for deployment of those results for consumption or decision making. To this end, the ML model tuning engine 922 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 918. A fully trained machine learning model 932 is one whose hyperparameters are tuned and model accuracy maximized.

The trained machine learning model 932, similar to any other software application output, can be persisted to storage, file, memory, or application, or looped back into the processing component to be reprocessed. More often, the trained machine learning model 932 is deployed into an existing production environment to make practical decisions based on live data 934 (such as, in accordance with the present invention, signals from beacons, data derived from beacon signals, movement/route maps and the like). To this end, the machine learning subsystem 900 uses the inference engine 936 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 938) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 938) live data 934 based on how similar they are to one another to solve exploratory challenges where little is known about the data, provide a description or label (e.g., C_1, C_2 . . . C_n 938) to live data 934, such as in classification, and/or the like. These categorized outputs, groups (clusters), or labels are then presented to the user input system 200. In still other cases, machine learning models that perform regression techniques may use live data 934 to predict or forecast continuous outcomes.

It will be understood that the embodiment of the machine learning subsystem 900 illustrated in FIG. 9 is exemplary and that other embodiments may vary. As another example, in some embodiments, the machine learning subsystem 900 includes more, fewer, or different components.

Thus, as described in detail above, present embodiments of the invention include systems, methods, computer program products and/or the like that provide for protection of sensitive data, such as Non-Public Information (NPI) or the like in video call/conference environment. Specifically, in response to initiating a video call/conference amongst multiple call participants, Artificial Intelligence (AI) is implemented to monitor for detection of sensitive data in the video feed and/or audio feed being transmitted by a call participant. In response to detecting sensitive data in the video feed or the audio feed, the invention is configured to perform one or more actions that prevent one or more other call participants participating in the video call from viewing and/or hearing the sensitive data in the video feed or the audio feed.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for sensitive data leakage prevention, the system comprising:
a computing platform including:
a memory;
at least one computing processor device in communication with the memory;
an image capturing device in communication with one or more of the at least one computing processor device; and
a video call application in communication with the image-capturing device and including Artificial Intelligence (AI), the video call application is stored in the memory, executable by one or more of the at least one computing processor device and configured to:
initiate a video call amongst a plurality of call participants,
implement the AI to detect sensitive data in at least one of a video feed or an audio feed being transmitted by a first call participant from amongst the plurality of call participants, and
in response to detecting the sensitive data in at least one of the video feed or the audio feed being transmitted by the first call participant, perform one or more actions that prevent one or more other call participants participating in the video call from at least one of viewing or hearing the sensitive data in the video feed or the audio feed.

2. The system of claim 1, wherein the video call application including the AI further comprises the AI including computer vision and optical character recognition (OCR) techniques and wherein the video call application is further configured to implement the AI including the computer vision and the OCR techniques to detect the sensitive data, wherein the sensitive data is text indicia displayed in a background of the video feed.

3. The system of claim 2, wherein the video call application is further configured to perform the one or more actions that prevent the one or more other call participants participating in the video call from at least one of viewing or hearing the sensitive data in the video feed or the audio feed, wherein the one or more actions includes obfuscating a region within the video feed where the text indicia appears.

4. The system of claim 1, wherein the video call application including the AI further comprises the AI including computer vision and facial recognition techniques and wherein the video call application is further configured to implement the AI including the computer vision and the facial recognition techniques to detect the sensitive data, wherein the sensitive data is at least one of (i) an actual individual in the video feed other than the first call participant and (ii) an image of individual in the video feed other than the first call participant.

5. The system of claim 4, wherein the video call application is further configured to perform the one or more actions that prevent the one or more other call participants participating in the video call from at least one of viewing or hearing the sensitive data in the video feed or the audio feed, wherein the one or more actions includes obfuscating a region within the video feed where the actual individual or the image of the individual appears.

6. The system of claim 1, wherein the video call application including the AI further comprises the AI including computer vision and voice recognition techniques and wherein the video call application is further configured to implement the AI and the voice recognition techniques to detect the sensitive data, wherein detection includes identifying one or more secondary voices in the audio feed other than a voice of the first call participant and wherein the sensitive data is any audio coming from the identified one or more secondary voices.

7. The system of claim 6, wherein the video call application further includes Natural Language Processing (NLP) and wherein the video call application is further configured to implement the AI, the voice recognition techniques and the NLP to detect the sensitive data, wherein detection further includes implementing the NLP to determine that the audio coming from the identified one or more secondary voices includes sensitive data.

8. The system of claim 6, wherein the video call application is further configured to perform the one or more actions that prevent the one or more other call participants participating in the video call from at least one of viewing or hearing the sensitive data in the video feed or the audio feed, wherein the one or more actions includes implementing noise reduction techniques to mute the audio coming from the identified one or more secondary voices.

9. The system of claim 1, wherein the video call application is further configured to, in response to detecting sensitive data in at least one of the video feed or the audio feed being transmitted by the first call participant and prior to performing the one or more actions, receive permission from the first call participant to perform the one or more actions.

10. The system of claim 1, wherein the video call application is further configured to:
detect that the first call participant is not in the video feed or not a primary subject in the video feed, and
in response to detecting that the that the first call participant is not in the video feed or not a primary subject in the video feed, pause or stop at least one of (i) capture of video by the image capture device or (ii) transmission of the video feed of the first call participant to the other call participants.

11. A computer-implemented method for sensitive data leakage prevention, the computer-implemented method executed by one or more computing processor device and comprising:
initiating a video call amongst a plurality of call participants;
implementing Artificial Intelligence (AI) to monitor for detection of sensitive data in at least one of a video feed or an audio feed being transmitted by a first call participant from amongst the plurality of call participants; and
in response to detecting the sensitive data in at least one of the video feed or the audio feed being transmitted by the first call participant, performing one or more actions that prevent one or more other call participants participating in the video call from at least one of viewing or hearing the sensitive data in the video feed or the audio feed.

12. The computer-implemented method of claim 11, wherein implementing further comprises implementing the AI including computer vision and Optical Character Recognition (OCR) techniques to detect the sensitive data, wherein the sensitive data is text indicia displayed in a background of the video feed and wherein performing further comprises performing the one or more actions that prevent the one or more other call participants participating in the video call from viewing the sensitive data in the video feed, wherein the one or more actions includes obfuscating a region within the video feed where the text indicia appears.

13. The computer-implemented method of claim 11, wherein implementing further includes implementing the AI including computer vision and facial recognition techniques to detect the sensitive data, wherein the sensitive is at least one of (i) an actual individual in the video feed other than the first call participant and (ii) an image of individual in the video feed other than the first call participant, and wherein performing further comprises performing the one or more actions that prevent the one or more other call participants participating in the video call from viewing the sensitive data in the video feed, wherein the one or more actions includes obfuscating a region within the video feed where the actual individual or the image of the individual appears.

14. The computer-implemented method of claim 11, wherein implementing further includes implementing the AI, voice recognition techniques and Natural Language Processing (NLP) to detect the sensitive data, wherein detection includes identifying one or more secondary voices in the audio feed other than a voice of the first call participant and implementing the NLP to determine that the audio coming from the identified one or more secondary voices includes sensitive data and wherein performing further comprises performing the one or more actions that prevent the one or more other call participants participating in the video call from at least one of hearing the sensitive data in the audio feed, wherein the one or more actions includes implementing noise reduction techniques to mute the audio coming from the identified one or more secondary voices.

15. The computer-implemented method of claim 11, further comprising:
detecting that the first call participant is no longer in the video feed or no longer a primary subject in the video feed; and
in response to detecting that the that the first call participant is no longer in the video feed or no longer a primary subject in the video feed, pausing or stopping at least one of (i) capture of video by the image capture device or (ii) transmission of the video feed of the first call participant to the other call participants.

16. A computer program product including a non-transitory computer-readable medium, the non-transitory computer-readable medium comprising sets of codes for causing one or more computing devices to:
initiate a video call amongst a plurality of call participants;
implement Artificial Intelligence (AI) to monitor for detection of sensitive data in at least one of a video feed or an audio feed being transmitted by a first call participant from amongst the plurality of call participants; and
in response to detecting the sensitive data in at least one of the video feed or the audio feed being transmitted by the first call participant, perform one or more actions that prevent one or more other call participants participating in the video call from at least one of viewing or hearing the sensitive data in the video feed or the audio feed.

17. The computer program product of claim 16, wherein the set of code for causing the one or more computing devices to implement are further configured to cause the one or more computing devices to implement the AI including computer vision and Optical Character Recognition (OCR) techniques to detect the sensitive data, wherein the sensitive data is text indicia displayed in a background of the video feed and wherein the set of code for causing the one or more computing devices to perform are further configured to cause the one or more computing devices to perform the one or more actions that prevent the one or more other call participants participating in the video call from viewing the sensitive data in the video feed, wherein the one or more actions includes obfuscating a region within the video feed where the text indicia appears.

18. The computer-program product of claim 16, wherein the set of code for causing the one or more computing devices to implement are further configured to cause the one or more computing devices to implement the AI including computer vision and facial recognition techniques to detect the sensitive data, wherein the sensitive data is at least one of (i) an actual individual in the video feed other than the first call participant and (ii) an image of individual in the video feed other than the first call participant, and wherein the set of code for causing the one or more computing devices to perform are further configured to cause the one or more computing devices to perform the one or more actions that prevent the one or more other call participants participating in the video call from viewing the sensitive data in the video feed, wherein the one or more actions includes obfuscating a region within the video feed where the actual individual or the image of the individual appears.

19. The computer program product of claim 16, wherein the set of code for causing the one or more computing devices to implement are further configured to cause the one or more computing devices to implement the AI, voice recognition techniques and Natural Language Processing (NLP) to detect the sensitive data, wherein detection includes identifying one or more secondary voices in the audio feed other than a voice of the first call participant and implementing the NLP to determine that the audio coming from the identified one or more secondary voices includes the sensitive data and wherein the set of code for causing the one or more computing devices to perform are further configured to cause the one or more computing devices to perform the one or more actions that prevent the one or more other call participants participating in the video call from at least one of hearing the sensitive data in the audio feed, wherein the one or more actions includes implementing noise reduction techniques to mute the audio coming from the identified one or more secondary voices.

20. The computer program product of claim 16, wherein the sets of codes further comprise sets of code for causing the one or more computing device to:
detect that the first call participant is no longer in the video feed or no longer a primary subject in the video feed; and
in response to detecting that the that the first call participant is no longer in the video feed or no longer a primary subject in the video feed, pause or stop at least one of (i) capture of video by the image capture device or (ii) transmission of the video feed of the first call participant to the other call participants.
